(19) United States
(12) Patent Application Publication
(10) Pub. No.: US 2016/0200055 A1
(43) Pub. Date: Jul. 14, 2016

(54) DEVICE FOR CONTINUOUSLY PREPARING ION EXCHANGE MEMBRANE

(71) Applicant: GWANGJU INSTITUTE OF SCIENCE AND TECHNOLOGY, Gwangju (KR)

(72) Inventors: Seung-Hyeon MOON, Gwangju (KR); Ju-Young LEE, Gwangju (KR); Ju-Hyuk LEE, Gwangju (KR); Sung-Hyun YUN, Gwangju (KR)

(21) Appl. No.: 14/995,939

(22) Filed: Jan. 14, 2016

(30) Foreign Application Priority Data
Jan. 14, 2015 (KR) 10-2015-0006524

(51) Int. Cl. B29C 71/00; B01D 71/52; B01D 67/00

(52) U.S. Cl. CPC B29C 71/0081; B01D 67/0009; B01D 71/52; B29K 2081/00

(57) ABSTRACT

The present disclosure relates to a technique for improving the ionic conductivity by introducing an electric field concept to a process for preparing an ion exchange membrane and deflecting ion channels within an ion exchange membrane in one direction, and specifically to a device for continuously preparing an ion exchange membrane with deflected ion channels in a roll-to-roll manner which can improve the ionic conductivity of the ion exchange membrane by reducing a traveling distance of the ions of the deflected ion channels.

### CROSS REFERENCE TO RELATED APPLICATION

This application claims the benefit of Korean Patent Application No. 10-2015-0006524, filed on Jan. 14, 2015, entitled “DEVICE FOR CONTINUOUSLY PREPARING ION EXCHANGE MEMBRANE”, which is hereby incorporated by reference in its entirety into this application.

### BACKGROUND

1. Technical Field

The present invention relates to a device for continuously preparing an ion exchange membrane, and more particularly to a device for continuously preparing an ion exchange membrane with aligned ion channels.

2. Description of the Related Art

An ion exchange membrane can be divided into a cation exchange membrane selectively permeable to cations and an anion exchange membrane selectively permeable to anions. This selective permeability to ions is due to the existence of inherent ion exchangers to which each of the ion exchange membranes is attached. For example, the cation exchange membrane contains fixed anions such as sulfonic acid group (—SO₃⁻), and the anion exchange membrane contains fixed cations such as amine group (NH₃⁺), in which these ion exchangers exert an attractive force to an counter charged ion and a repulsive force to an identically charged ion, which renders possible to provide a selective ion exchange.

A number of ion channels with these ion exchangers attached thereto are formed inside the ion exchange membrane. Studies on the ion channels have been consistently presented using a film of Nafion™. According to the analysis, such as Electro-Spin Resonance (ESR), Small Angle X-ray Scattering (SAXS), Nuclear Magnetic Resonance (NMR), etc., aggregates of ion exchangers, also referred to as a cluster, are present in the film of Nafion™, and ion channels are extended and connected to the aggregates in various directions.

The traveling time of the ions is dependent on the length of the ion channels formed in the ion exchange membrane, which results in a long distance traveling path of the ions by the ion channels extended toward various directions as mentioned above, and therefore rapid movement of the ions cannot be expected. In order to solve this problem, the ion traveling distance is intended to be drastically reduced by deflecting the ion channels to a desired direction, such that a significantly fast and efficient movement of the ions can be achieved.

Conventionally, there have been extremely concentrated on the development of new materials with polymer structure to improve the ionic conductivity of the ion exchange membrane. However, the development of new materials is complicated in the synthetic procedures and dangerous due to chemical reaction, as well as such development requires high production cost and troublesome production process for commercialization.

### RELATED PRIOR ART

Patent Document 1: Korean Laid-open Patent Publication No. 2004-0092332

Patent Document 2: Korean Laid-open Patent Publication No. 2008-0083805

### SUMMARY

One aspect of the present disclosure is to provide a technical concept that can be applied to any type of ion exchange membrane rather than the development of new materials, and propose a way to improve the ionic conductivity without regard to the type of ion exchangers.

Further, in order to improve the ionic conductivity of the ion exchange membrane, another aspect of the present disclosure is to provide a device for continuously preparing an ion exchange membrane in which ion channels are aligned in one direction during the manufacturing process of the ion exchange membrane.

To this end, there is provided a method including displacing a material comprising fixed ions between a positive electrode and a negative electrode, and aligning the fixed ions in an electric field direction, and particularly to a method including passing the material continuously through a region where the electric field is applied to continuously align the inner fixed ions, thereby capable of improving the properties of the material.

In particular, there is provided a device for continuously preparing an ion exchange membrane with improved ionic conductivity by deflecting the ion channels present in the material to minimize the traveling distance of the ions, and particularly to a device for continuously forming an ion exchange membrane by deflecting ion exchangers attached to a polymer backbone in a polymer solution in one direction to form ion channels and maintain the same as formed.

The technique of the present disclosure is applicable without regard to the polymer structure and the type of the ion exchangers.

The technique of the present disclosure can provide an ion exchange membrane with 4 to 10 fold increased ionic conductivity under the same conditions in terms of ion exchange capacity as compared to an ion exchange membrane prepared by a conventional method.

Since the present disclosure includes a further process of forming an electric field only during the manufacturing process of the ion exchange membrane, it is easily modified from the existing manufacturing process of the ion exchange membrane, and therefore applicable to a wider field of art.

The continuously manufacturing device of the present disclosure allows a substrate having an impregnated polymer solution to pass through an electric field area at a constant rate, to continuously produce an ion exchange membrane having aligned ion channels, which can thus guarantee excellent productivity.

The continuously manufacturing device of the present disclosure allows a substrate having an impregnated polymer solution to pass through in contact with a casting rod to which a voltage is applied, such that it can be prepared at a considerably lower voltage than a non-contact alignment method of the ion channels and energy effective.

### BRIEF DESCRIPTION OF DRAWINGS

The above and other objects and features of the present invention will become apparent from the following description of the disclosure, when taken in conjunction with the accompanying drawings, in which:

FIG. 1 shows a formula of sulfonated poly(2,6-dimethyl-1,4-phenylene oxide) (SPPO).

FIGS. 2a and 2b show a schematic plan view and side view of a device for aligning ion channels using an electric field, respectively.

FIG. 3 shows the current changes and dipole angle observed during the electric field is applied.

FIG. 4 respectively shows that if the measurement direction of deflected ion exchange membrane resistance is direction S1, the deflected direction of predicted ion channels is perpendicular to the direction of measuring electrodes, and if direction S2, then the deflected direction of predicted ion channels is parallel to the direction of measuring electrodes.

FIGS. 5a and 5b show AFM images for each of the conventional ion exchange membranes in which the ion exchange membranes and ion channels are aligned, respectively.

FIGS. 6a and 6b show FE-TEM images for each of the conventional ion exchange membranes in which the ion exchange membranes and ion channels are aligned, respectively.

FIGS. 7a and 7b show TEM images for each of the conventional ion exchange membranes in which the ion exchange membranes and ion channels are aligned, respectively.

FIGS. 8a and 8b show a schematic top view and side view of the continuously preparing device for aligning ion channels in a thickness direction, respectively.

### DETAILED DESCRIPTION

Hereinafter, embodiments of the present disclosure will be described in detail with reference to the accompanying drawings. It should be understood that the present disclosure is not limited to the following embodiments, and that the embodiments are provided for illustrative purposes only. The scope of the disclosure should be defined only by the accompanying claims and equivalents thereof.

The present disclosure relates to a method including displacing a material comprising fixed ions between a positive electrode and a negative electrode, and aligning the fixed ions in an electric field direction, and particularly to a method including passing the material continuously through a region where the electric field is applied in order to continuously align the inner fixed ions, thereby capable of improving the properties of the material.

In particular, the present disclosure is directed to a device for continuously preparing an ion exchange membrane with improved ionic conductivity by deflecting the ion channels present in the material to minimize the traveling distance of the ions, and particularly to a device for continuously forming an ion exchange membrane by deflecting ion exchangers attached to a polymer backbone in a polymer solution in one direction to form the ion channels and maintain the same as formed.

That is, the device for continuously preparing an ion exchange membrane may include (a1) a first motor, (a2) a second motor, (b1) a first roller, (b2) a second roller, (c) a porous substrate, (d) a polymer solution, (e1) an anode casting rod, (e2) a cathode casting rod, and (f) a power supply. Particularly, the inventive device may include (a1) a first motor 9, (a2) a second motor 10, (b1) a first roller 11 driven by the first motor, (b2) a second roller 12 driven by the second motor, (c) a porous substrate 21 which is to be rolled while moving from the first roller as rolled to the second roller, (d) a polymer solution 22 into which the porous substrate is immersed while moving from the first roller to the second roller, and (e1) an anode casting rod 8a and (e2) a cathode casting rod 8b, which are located up and down the porous substrate and capable of applying an electric field thereto after the immersion of the porous substrate into the polymer solution and before the rolling of the porous substrate around the second roller, and (f) a power supply 24 which is capable of applying an electric field to the anode casting rod and the cathode casting rod.

According to one embodiment, the device for continuously preparing an ion exchange membrane may further include (g) an ammeter and (h) a power supply control unit. That is, the device for continuously preparing an ion exchange membrane in accordance with an embodiment may further include (g) an ammeter which can measure a current supplied from the power supply, and (h) a power supply control unit which allows supplying a constant current from the power supply.

According to another embodiment, the device for continuously preparing an ion exchange membrane may further include (i) a thickness control unit. That is, the device for continuously preparing an ion exchange membrane according to another embodiment may further include a thickness control unit 20 which can adjust the gap between the anode casting rod and the cathode casting rod.

The present disclosure may include a method for continuously preparing a cation exchange membrane in which the fixed ions may include a negatively charged ion such as SO₃⁻, COO⁻, PO₃²⁻, PHO₂⁻, AsO₃²⁻ and SeO₃⁻, or a method for continuously preparing an anion exchange membrane in which the fixed ions may include a positively charged ion such as a primary amine group, a secondary amine group, a tertiary amine group, a quaternary ammonium group, a polyethylene imine group, and a phosphonium group.

Materials for the anode and the cathode may be selected from a glassy carbon electrode, a graphite electrode, a silver electrode, a platinum electrode, a gold electrode, a nickel electrode, a copper electrode, and a foil. The polymers may include a hydrocarbon polymer, a fluorinated polymer, a partially fluorinated polymer, and an aliphatic hydrocarbon-based polymer. An organic solvent available for the polymer solution may include toluene, dimethyl acetamide, dimethylformamide, chloroform, methylene chloride, methanol, hexane, ethyl acetate, acetone, dimethyl sulfoxide, dimethyl formaldehyde, and the like. In addition, examples of the porous substrate may include, but are not limited to, polyethylene, polytetrafluoroethylene, polypropylene, polyvinylidene fluoride, and the like.

According to another embodiment, the polymer solution is a solution in which a sulfonated poly(2,6-dimethyl-1,4-phenylene oxide) polyester having an ion exchange capacity of from 1 to 3 meq/g is dissolved. The ion exchange membrane continuously prepared in the present disclosure should have uniform physical properties (i.e., physical property uniformity in a longitudinal direction) independent of the time at which it is manufactured. It has been found that the physical property uniformity in a longitudinal direction can be significantly improved by precisely adjusting the ranges of the ion exchange capacity of the polymer dissolved in the polymer solution. That is, outside the above numerical range, the ion exchange membrane prepared using the device of the present disclosure may have significantly increased proton conductivity along the longitudinal direction, which results in turn significantly reduced physical property uniformity in the longitudinal direction. This is mainly because the ion exchangers are not evenly distributed in the longitudinal direction and aggregated in part. In order to prevent this aggregation of the ion exchangers and increase the uniformity of the proton conductivity in the longitudinal direction, it is important to use a polymer solution in which a sulfonated poly(2,6-dimethyl-1,4-phenylene oxide) having an ion exchange capacity of from 1 to 3 meq/g is dissolved.

According to another embodiment, the polymer solution has a ratio (w/v/v) of sulfonated poly(2,6-dimethyl-1,4-phenylene oxide)/dimethyl acetate/methanol of 1:1.5-2.5:1-2. The ion exchange membrane continuously prepared in the present disclosure should have a uniform physical property also in a width direction. It has been found that the physical property uniformity in the width direction can be significantly improved by precisely adjusting the solvent type and the amount of the polymer solution. That is, in the case where the polymer used has an ion exchange capacity of 1 to 3 meq/g of sulfonated poly(2,6-dimethyl-1,4-phenylene oxide), if a solvent other than a mixed solvent of dimethyl acetate and methanol is used, or if the ratio value is out of the above range, the uniformity of the physical property in the width direction for the ion exchange membrane continuously prepared may be significantly degraded.

According to another embodiment, (i) the porous substrate is moved at from 0.005 to 0.015 cm/sec, (ii) the porous substrate has a thickness of 12 to 38 and (iii) the thickness which is kept constant by the thickness control unit is 14 to 40 It is important that the sulfonated polymer according to the present disclosure is fully impregnated into the porous substrate (pore-filling). If it is not sufficiently impregnated thereinto, the sulfonated polymer is separated from the porous substrate during operation, causing overall performance degradation. In order to prevent such separation and ensure sufficient impregnation, the running speed of the porous substrate and the thickness of the porous substrate and its surface and the sulfonated polymer impregnated into the pores are important. That is, if the running speed of the porous substrate is out of the above numerical range, or if the thickness of the porous substrate is out of the above numerical range, or if the overall thickness of the porous substrate and its surface and the sulfonated polymer impregnated into the pores are out of the above numerical range, sufficient impregnation cannot be done, thereby yielding a significantly degraded durability of the ion exchange membrane.

Hereinafter, the present disclosure will be described in more detail with reference to some examples. It should be understood that the following examples are provided for illustrative purposes only and are not to be in any way construed as limiting the present disclosure.

### EXAMPLES

### Preparation Example 1

### Synthesis of Polymer and Preparation of Polymer Solution

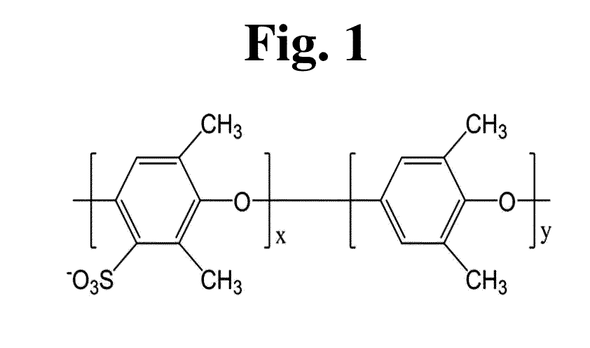

Sulfonated poly(2,6-dimethyl-1,4-phenylene oxide) (SPPO) (ion exchange capacity: 2.5 meq/g) was synthesized through the following process. 20 g of PPO was dissolved in 200 mL of chloroform, and then 3.5 mL of chlorosulfonic acid was slowly injected to sulfonate the PPO to obtain the SPPO as shown in FIG. 1. 4 g of the harvested SPPO and 16 mL of dimethyl acetamide were stirred to yield the polymer solution.

### Preparation Example 2

### Alignment of Ion Channels

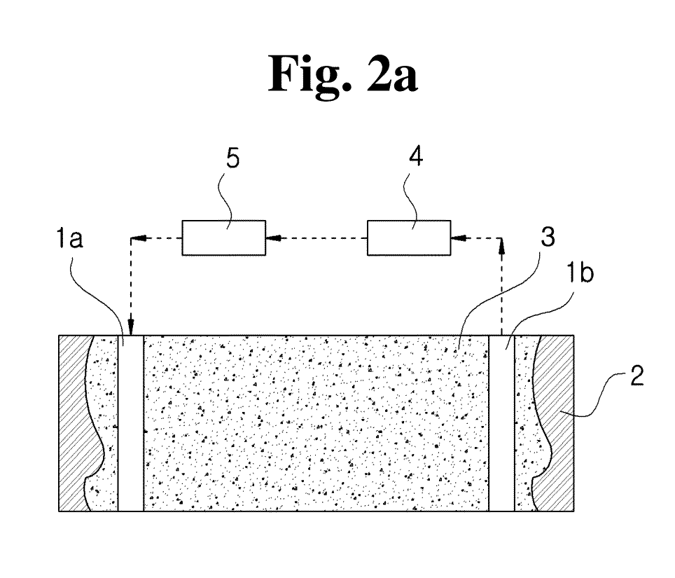

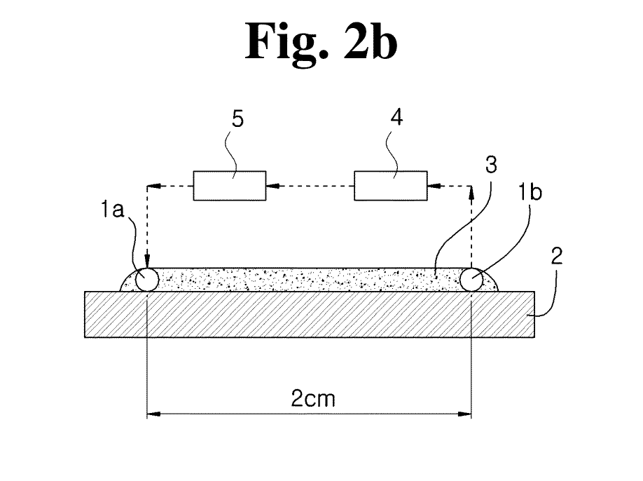

The following experiment was carried out to align the ion channels using an electric field, and the ion channels were aligned in a surface direction to facilitate the analysis of the ion channels. As shown in FIG. 2, platinum wires 1a and 1b were fixed with a distance of 2 cm on the glass plate 2. A power supply 5 for supplying a voltage and a pico-ammeter 4 for measuring the current flow as the electric field is formed 4 were connected in series. The polymer solution 3 prepared as above was casted over the two platinum wires 1a and 1b, and 50 V of voltage was applied to the two platinum wires 1a and 1b to form an electric field. Ion exchangers were allowed to stand for one hour while the electric field is formed to respond to the field. At the same time, the current was measured to observe a phenomenon that occurs in the polymer solution. After one hour, the applied voltage was removed, and the polymer solution was allowed to stand for additional two hours under the same conditions to remove the solvent completely. The prepared ion exchange membrane was soaked in 0.1 N of sulfuric acid solution for 6 hours for acid rinsing. Then, the remaining acid on the surface of the ion exchange membrane was rinsed with distilled water, and then soaked and stored in fresh distilled water.

### Comparative Preparation Example 1

### Preparation of Ion Exchange Membrane for Control

The polymer solution 3 prepared in Preparation Example 1 above was casted on a glass plate 2, and held on a heater at 60° C. for three hours to dry the solvent completely. The prepared ion exchange membrane was soaked in 0.1 N of sulfuric acid solution for 6 hours for acid rinsing. Then, the remaining acid on the surface of the ion exchange membrane was rinsed with distilled water, and then soaked and stored in fresh distilled water.

### Test Example 1

### Measurement of Current

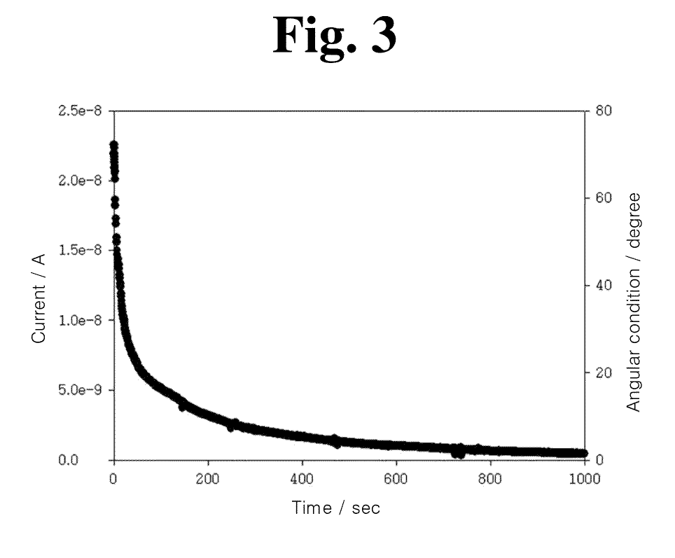

Current change means that the movement of the electric charge is generated in the polymer solution. Therefore, it is possible to check a reaction degree and an alignment of the ion exchangers by measuring the current in response to an electric field. As shown in FIG. 3, it was confirmed that the current converged to 0 ampere over time. This means that the movement of the electric charge took place actively at an early stage when the electric field was applied and it had gradually stopped over time.

When viewed from the perspective of the theory that the dipole is rotated by an external electric field, the dominant cause of the current shown in the figure above is the rotation of the dipole. Relationship between the current and the dipole alignment can also be interpreted numerically. The external electric field is forced to rotate the dipole to generate a rotational energy, and the energy can be expressed in combination with an electrical energy by the following equation.

I=\sqrt{nEqd(1−cos θ)/R} (1)

where I denotes a current (A), n denotes the number of molecules, E denotes an external electric field (V/m), q denotes a charge (C), d denotes is a distance (m) between two dipole particles, θ is an angle (°) of the dipole and the electric field, and R denotes a resistance (Ω) of membrane, respectively. In the equation above, since all but the angle of dipole and the electric field (hereinafter, “dipole angle”) are constant values, the current changes can be represented by the changes in the dipole angle. When calculated in connection with the current and the dipole angle observed in FIG. 3, it can be found that initially the average angle of the dipole gradually decreased from about 73.2° to 0°. That is, it can be found that all the dipoles were aligned due to the influence of the electric field.

### Test Example 2

### Measurement of Proton Conductivity in Surface Direction

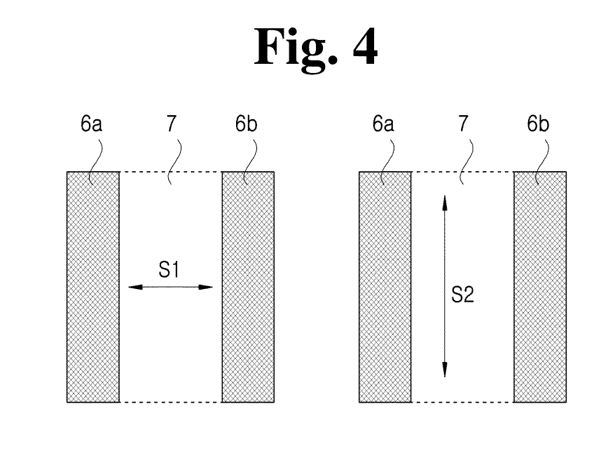

In order to confirm the alignment of the ion channels, the resistance of the ion exchange membrane was measured in a biased direction, and the proton conductivity was calculated by the result. As suggested in FIG. 4, it was measured based on where the deflected direction of the ion channels is perpendicular or parallel to the direction of the measuring electrodes. The resistance of the ion exchange membrane was measured using an impedance meter (AutoLab, PGSTAT30) with four-electrode system. The proton conductivity was calculated from the measured resistances by the following equation, and the results are given in Table 1.

$$σ = \frac{L}{R \cdot w \cdot d} \qquad ( 2 )$$

where σ denotes a proton conductivity (S/cm), R denotes a resistance (Ω) of the ion exchange membrane, w denotes a width (cm) of the ion exchange membrane, d denotes a thickness (cm) of the ion exchange membrane, and L denotes a distance (cm) between the measuring electrodes.

TABLE 1

| | Direction S1 | Direction S2 |
|---|---|---|
| Conventional ion exchange membrane | 8.0 mS/cm | 7.1 mS/cm |
| Ion exchange membrane with aligned | 22.0 mS/cm | 4.8 mS/cm |
| ion channels | | |

The proton conductivity in a surface direction was compared using the ion exchange membrane with aligned ion channels prepared in Preparation Example 2 and the conventional ion exchange membrane prepared in Comparative Preparation Example 1. The proton conductivities measured for the conventional ion exchange membrane show very similar results in directions S1 and S2, which indirectly demonstrate that the ion channels were extended in various directions while they are not deflected conditions. Meanwhile, the ion exchange membrane with aligned ion channels shows a proton conductivity of 22.0 mS/cm in direction S1, and 4.8 mS/cm in direction S2. Such a big difference depending on the direction of measurement suggests that the ion channels were deflected.

As in direction S1, when the deflected direction of the predicted ion channels is arranged perpendicular to the direction of the measuring electrodes, since the ion channels connect the two measuring electrodes, the protons can naturally flow from one measuring electrode through the ion channels to the opposite measuring electrode, thereby capable of obtaining higher proton conductivity. On the contrary, as in direction S2, when the deflected direction of the predicted ion channels is arranged parallel to the direction of the measuring electrodes, the ion channels do not cover the two measuring electrodes at the same time. In this case, since the protons flowing at one measuring electrode fail to have straightforward flow passages (ion channels) for moving toward the opposite measuring electrode, higher resistance of the ion exchange membrane is noted and higher proton conductivities are reported compared with direction S1. Therefore, the results demonstrate that the ion channels can be arranged by an electric field, which further means that the ion channels can be arranged in any desired direction according to the present disclosure.

### Test Example 3

### AFM Analysis

Atomic Force Microscopy (AFM) can analyze the surface of the ion exchange membrane to distinguish between lipophilic and hydrophilic properties. Since the ion channels contain water molecules, they show a hydrophilic nature, and the hydrocarbon and benzene-based backbones of the polymers used in the preparation of the ion exchange membrane show a lipophilic nature. This test example was carried out using AFM (XE-100, Park System) equipped with a non-contact mode tip (PPP-NCHR, Nanosensors), and the conventional ion exchange membrane prepared in Comparative Preparation Example 1 and the ion exchange membrane with aligned ion channels prepared in Preparation Example 2 were analyzed for their surface to compare the shape of the ion channels.

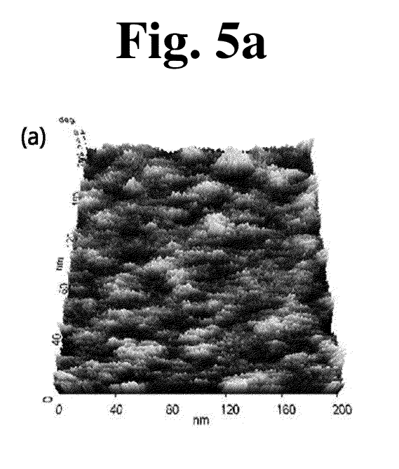

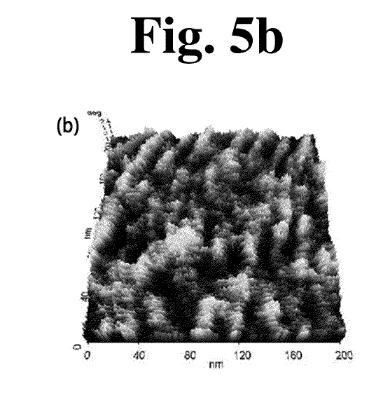

The image of the conventional ion exchange membrane shown in FIG. 5a suggests that since the aggregates of the ion exchange membrane (cluster) are dispersed in any locations and fail to form a prominent cylindrical shape of ion channels. On the contrary, FIG. 5b shows that the ion channels having a diameter of 15 to 18 nm form a cylindrical shape and extend in one direction. This image demonstrates that the ion channels are deflected under electric field.

### Test Example 4

### TEM Analysis

The shape of the ion channels in the ion exchange membrane was analyzed through a transmission electron microscope (TEM). Since the TEM analysis was carried out so that the electrons passed through the ion exchange membrane for analysis, the ion channels extended inside the ion exchange membrane could be profiled. In order to maximize the color contrast of the image, the ion channels were dyed with Pb ions using 1 M Pb(NO₃)₂ solution, and then subjected to TEM analysis. The TEM analysis was carried out using a field emission transmission electron microscope (FE-TEM, JEM-2100F, JEOL) and a transmission electron microscopy (TEM, JEM-2100, JEOL). The difference between the FE-TEM and TEM may be a resolution due to the difference in the filament used in the analysis. In order to compare the shape of the ion channels, the ion exchange membrane with aligned ion channels and the conventional ion exchange membrane were analyzed for the comparison thereof.

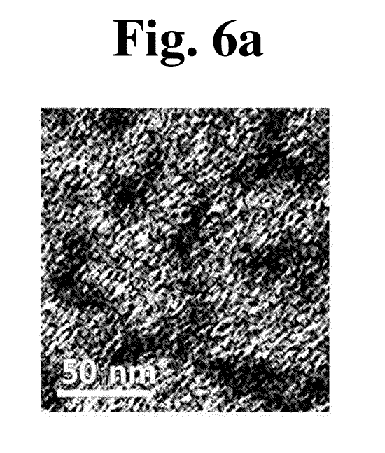

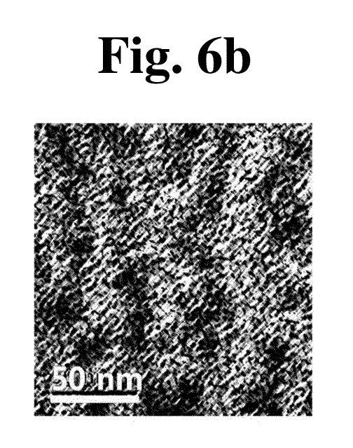

The dark areas in the FE-TEM image are the ion channels having dyed Pb ions. Relatively light areas are the backbone parts of the polymer used in the preparation of the ion exchange membrane. In FIG. 6a for a conventional ion exchange membrane, ion channels are extended in various directions. On the contrary, in FIG. 6b for the ion exchange membrane with aligned ion channels, ion channels are deflected and extended in one direction. The diameter of one ion channel is 18.6 to 21.1 nm, which was similar to the diameter of the ion channel observed in the AFM.

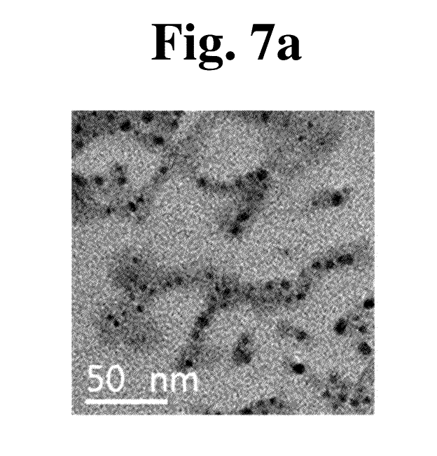

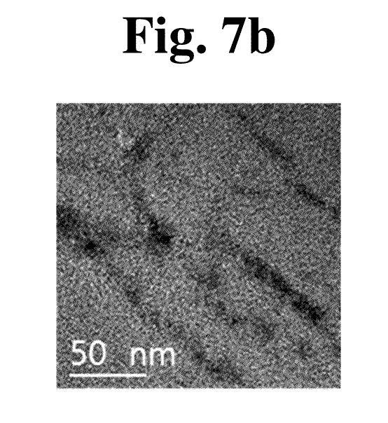

In the TEM images shown in FIGS. 7a and 7b, more reliable shapes of Pb particles can be seen. The shapes are very similar to those in the FE-TEM images of FIG. 6. For the conventional ion exchange membrane, ion channels are extended in non-uniform directions, while for the ion exchange membrane with aligned ion channels, the ion channels are extended in one direction. Therefore, these results demonstrate that the ion channels within the ion exchange membrane can be aligned by an electric field formed at the time of preparing the membrane.

### Example 1

### Continuously Preparing Device for the Alignment of Ion Channels in Thickness Direction

In order to apply to an electrochemical-based energy storage system, an energy generating system and a water treatment system, the ion channels of the ion exchange membrane should be arranged in a thickness direction. As confirmed from the above results in Test Example 2, since the ion channels are deflected depending on the direction of an electric field, it is necessary to form the electric field in the thickness direction in order for the ion channels to be aligned in the thickness direction.

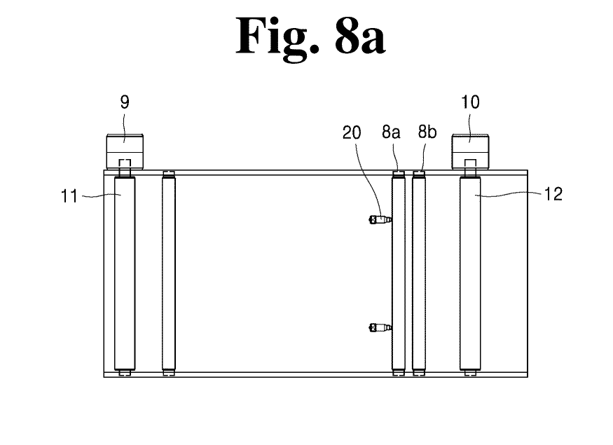

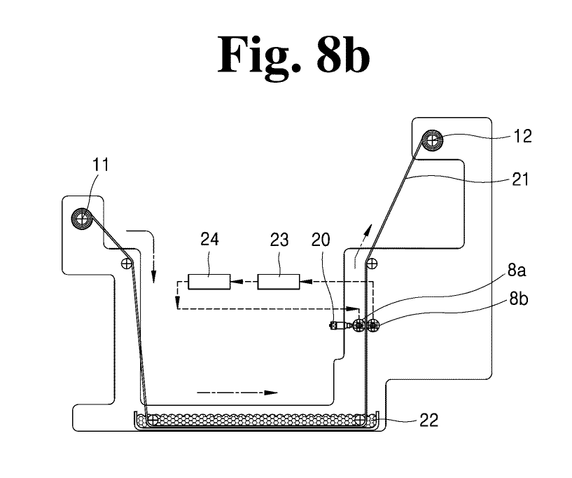

The device for continuously preparing the ion channels according to an embodiment of the present disclosure is a continuously preparing device in a roll-to-roll manner, as shown in FIG. 8. The device was designed based on pore-filling technique where a porous substrate is immersed in a polymer solution to fill the substrate pores with the polymer. For example, porous substrate 21 of polyethylene (PE) was wound around the left roller 11, and then moved to the right at a constant rate of 0.01 cm/sec. The movement was regulated by each of circular motors 9 and 10 equipped in the left roller 11 and the right roller 12. While moving, the porous substrate 21 was immersed in the polymer solution 22 prepared in Test Example 1 to which methanol was added (SPPO:DMAc:MeOH=1:2:1.6 (w/v/v)), and the polymer solution filled the pores in the substrate.

After completing the filling, the ion exchange membrane moved to the right roller 12, while the ion exchange membrane was transferred between the anode casting rod 8a and the cathode casting rod 8b having received a voltage supplied from power supply unit 24. Ion exchangers in the polymer solution were aligned in the thickness direction by the electric field generated by the two roller bar. The spacing between the casting rods 8a and 8b was controlled to adjust the thickness of the membrane at a constant membrane thickness by thickness control unit 20. The alignment and short circuit of the ion channels were checked in real time by monitoring the current through ammeter 23.

In order to confirm the alignment degree of the ion channels according to the strength of the electric field, the ion exchange membranes were prepared under the conditions of 0.4 V, 0.8 V, 1.2 V, and 1.6 V, respectively, while conventional ion exchange membrane for control group was additionally prepared without applying the electric field.

### Test Example 5

### Measurement of Proton Conductivity in Thickness Direction

The proton conductivity was measured to confirm the alignment degree of the ion channel. The ion channels were aligned in the thickness direction of the ion exchange membrane. The proton conductivity was measured using a resistance measurement system in thickness direction disclosed in Korean Paten No. 1237771. The resistance of the ion exchange membrane was measured using impedance meter (AutoLab, PGSTAT30). The proton conductivity was calculated from the measured resistance by the following equation, and the results are presented in Table 2 below.

$$σ = \frac{d}{R \cdot A} \qquad ( 3 )$$

where σ denotes a proton conductivity (S/cm), R denotes a resistance of ion exchange membrane (Ω), A denotes a width of ion exchange membrane (cm²), and d denotes a thickness (cm) of ion exchange membrane, respectively.

TABLE 2

| Potential (V) | 0 | 0.4 | 0.8 | 1.2 | 1.6 |
|---|---|---|---|---|---|
| Proton | 4.2 | 14.5 | 18.9 | 7.8 | 4.6 |
| conductivity | | | | | |
| (mS/cm) | | | | | |

Generally, the ion exchange membranes prepared under the electric field show higher proton conductivities than the ion exchange membrane prepared without the electric field. These results demonstrate that the ion channels were deflected depending on the generation of the electric field, and the proton conductivities were enhanced. Particularly, the greatest difference in the proton conductivity of the ion exchange membrane was shown between the ion exchange membrane prepared under the condition of 0.8 V, and the conventional ion exchange membrane.

The values of the proton conductivities varied in accordance with the applied voltage, which means that the alignment degree of the ion channels depends on the strength of the applied electric field. We could find that the proton conductivity in accordance with the strength of the voltage was increased up to 0.8 V, but it was rather decreased after 1.2 V. It is believed that although since the electric field increases as the applied voltage increases, the ion channels can be accordingly aligned more quickly and efficiently, if an excessive voltage is applied, the main chain of the polymer or the dipole type intended to be aligned may be disrupted to cause the degradation of the polymer, which eventually leads to irregular shape changes.

Consequently, it could be found that the ion exchange membrane prepared under the proper voltage conditions has about 4 to 5 times higher ionic conductivity than a normal ion exchange membrane. Accordingly, the application of the inventive ion exchange membrane to an electrochemical-based energy storage system, an energy generating system, and a water treatment system is expected to give an improved efficiency.

What is claimed is:

1. A device for continuously preparing an ion exchange membrane, comprising: (a1) a first motor; (a2) a second motor; (b1) a first roller; (b2) a second roller; (c) a porous substrate; (d) a polymer solution; (e1) an anode casting rod; (e2) a cathode casting rod; and (f) a power supply.

2. The device of claim 1, further comprising (g) an ammeter, and (h) a power supply control unit.

3. The device of claim 1, further comprising (i) a thickness control unit.

4. The device of claim 1, wherein the polymer solution is a solution in which a sulfonated poly(2,6-dimethyl-1,4-phenylene oxide) having an ion exchange capacity of from 1 to 3 meq/g is dissolved.

5. The device of claim 4, wherein the polymer solution has a ratio (w/v/v) of sulfonated poly(2,6-dimethyl-1,4-phenylene oxide)/dimethyl acetate/methanol of 1:1.5 to 2.5:1 to 2.

6. The device of claim 5, wherein the porous substrate is moved at from 0.005 to 0.015 cm/sec, the porous substrate has a thickness of 12 to 38 and the thickness which is kept constant by the thickness control unit is 14 to 40 μm.
